(19) United States
(12) Patent Application Publication
(10) Pub. No.: US 2021/0108714 A1
(43) Pub. Date: Apr. 15, 2021

(54) INTELLIGENT LUBRICANT SPRAYING SYSTEM FOR HIGH-SPEED GEAR TRANSMISSION AND CONTROL METHOD THEREOF

(71) Applicant: Jilin University, Changchun (CN)

(72) Inventors: Yulong LEI, Changchun (CN); Fuchun JIA, Changchun (CN); Yao FU, Changchun (CN); Binyu WANG, Changchun (CN); Guanzheng WEN, Changchun (CN)

(21) Appl. No.: 17/017,834

(22) Filed: Sep. 11, 2020

(30) Foreign Application Priority Data
Oct. 15, 2019 (CN) 201910976376.9

(51) Int. Cl. F16H 57/04

(52) U.S. Cl. CPC F16H 57/046; F16H 57/0495; F16H 57/0449; F16H 57/0436

(57) ABSTRACT

The present invention discloses an intelligent lubricant spraying system for a high-speed gear transmission, which comprises an oil tank, an oil pump, a driving gear, a driven gear, and a spray nozzle. One end of the oil pump is communicated with the oil tank through the first oil inlet pipe. The driving gear is rotatably supported above the oil tank. The driven gear is meshed with the driving gear and is rotatably supported above the oil tank. The spray nozzle is communicated with the other end of the oil tank through the second oil inlet pipe. The spray nozzle is supported between the driving gear and the driven gear and is used for spraying a lubricant in the oil tank into a meshing part of the driving gear and the driven gear.

### CROSS-REFERENCE TO RELATED APPLICATIONS

A claim for priority under 35 U.S.C. § 119 is made to Chinese Patent Application No. CN2019/10976376.9 filed on Oct. 15, 2019 in the China National Intellectual Property Administration (CNIPA), the entire contents of which are hereby incorporated by reference.

### TECHNICAL FIELD

The present invention relates to an intelligent lubricant spraying system for a high-speed gear transmission and a control method thereof, and belongs to the field of gear lubrication.

### BACKGROUND

A gear transmission is an important element of the machinery equipment and has the functions of power transmission, speed change, and direction change. A gear is an important mechanical component for transmitting motion and power through the mutual friction of the meshed tooth surfaces. The gear transmission generally is: a pair of gears are respectively mounted on the driving shaft and the driven shaft, and their teeth are mutually meshed to transmit motion and power. The gear transmission is widely applied to various modern machines for power transmission, speed change, connection, and the like. However, in use, although there are many failure forms because the gear is damaged and cannot achieve its designed service life, the early failure form of the gear caused by incorrect lubrication is in the majority. With the development of the gear transmission towards the aspects of high speed and heavy load, correct lubrication of the gear transmission is more and more important. Currently, the closed straight gear transmission mostly utilizes splash lubrication.

Specifically, the gears rotate to bring the lubricant into their meshing parts to lubricate and cool down them. However, in such lubrication manner, the quantity of the lubricant is hard to be adjusted. Furthermore, impurities in the lubricant are easy to be brought into the meshing parts to damage the gears, so as to shorten the service lives of the gears. Moreover, with the increasing of the rotational speed of the gear transmission, the huge centrifugal force generated in the high-speed rotation of the gears makes the lubricant hard to be attached to the gears; so, the quantity of the lubricant entering the meshing parts is few, causing that the lubrication is insufficient. Besides, the high-speed rotation causes huge churning loss, seriously influencing the efficiency of the gear transmission.

### SUMMARY

The present invention designs and develops an intelligent lubricant spraying system for a high-speed gear transmission. A spray nozzle sprays the lubricant to lubricate gears, so as to separate the gears from the interface of the lubricant. Thus, there is no churning loss, the gears are always in excellent lubrication state, and the friction loss is reduced.

The present invention further designs and develops a control method of an intelligent lubricant spraying system for a high-speed gear transmission, which can control the rotational speed of an oil pump according to the height of the lubricant in an tank, so as to adjust the lubricant spraying quantity and improve the lubricating efficiency of the gear.

The present invention provides the following technical solutions:

An intelligent lubricant spraying system for a high-speed gear transmission comprises:

an oil tank;

an oil pump, on end of which is communicated with the oil tank through the first oil inlet pipe;

a driving gear, which is rotatably supported above the oil tank;

a driven gear, which is meshed with the driving gear and is rotatably supported above the oil tank;

a spray nozzle, which is communicated with the other end of the oil tank through the second oil inlet pipe, is supported between the driving gear and the driven gear, and is used for spraying a lubricant in the oil tank into a meshing part of the driving gear and the driven gear.

Preferably, the intelligent lubricant spraying system for a high-speed gear transmission further comprises:

a filter. One end of the filter is arranged in the oil tank in a communication manner while the other end is communicated with one end of the oil pump through the first oil inlet pipe.

Preferably, the first oil inlet pipe and the second oil inlet pipe are high-pressure oil pipes.

Preferably, the spray nozzle has a sector-shaped structure.

Preferably, the intelligent lubricant spraying system for a high-speed gear transmission further comprises:

a gear rotational speed sensor, which is arranged on the driving gear and is used for monitoring the rotational speed of the driving gear;

a torque sensor, which is arranged on the driving gear and is used for monitoring the torque of the driving gear;

a liquid level gauge, which is arranged in the oil tank and is used for monitoring the height of the liquid level in the oil tank;

an oil pump rotational speed sensor, which is arranged on the oil pump and is used for detecting the rotational speed of the oil pump;

a controller, which is respectively electrically connected with the gear rotational speed sensor, the torque sensor, the liquid level gauge, and the oil pump and is used for receiving monitoring signals from the gear rotational speed sensor, the torque sensor, the liquid level gauge, and the oil pump, and controlling the rotational speed of the oil pump.

A control method of an intelligent lubricant spraying system for a high-speed gear transmission utilizes the above intelligent lubricant spraying system for a high-speed gear transmission, and specifically comprises:

determining the height h of the liquid level of the lubricant in the oil tank:

when h<0.01h₀, determining that the actual rotational speed r of the oil pump is 0.1nₚ;

wherein h₀ is the initial height of the liquid level of the lubricant in the oil tank; nₚ is the maximum rotational speed of the oil pump;

when h≥0.01h₀, controlling the actual rotational speed r of the oil pump through a PID controller.

Preferably, the control method of an intelligent lubricant spraying system for a high-speed gear transmission further comprises:

inputting the torque f of the driving gear and the rotational speed v₁ of the driving gear into a fuzzy controller, and outputting the ideal rotational speed r̅ of the oil pump;

wherein the torque f of the driving gear, the rotational speed v₁ of the driving gear, and the ideal rotational speed r̅ of the oil pump are classified into four grades, and an input and output fuzzy set is {VS, B, VB};

inputting a deviation e as well as a deviation variation rate ec of the actual rotational speed r of the oil pump and the ideal rotational speed r̅ of the oil pump in the i-th control process into the PID controller; conducting error compensation control on the actual rotational speed r of the oil pump through the PID controller.

Preferably, the empirical formula of the outlet volumetric flow rate Q of the spray nozzle is:

$$Q = {k}_{f} \cdot \frac{{( \frac{{T}_{i} - {T}_{0}}{{T}_{i}} )}^{{e}^{0.118 \frac{r}{{r}_{0}}}} \cdot {( 1 - {k}_{Q} \cdot \frac{{S}_{2}}{{S}_{1}} )}^{2} + 2.4638}{{k}_{c} \cdot \sqrt{0.992 {( \frac{{P}_{0}}{{P}_{i}} )}^{2} + 0.0007 ( \frac{{P}_{0}}{{P}_{i}} ) - 0.0002}} \cdot {Q}_{v} ,$$

wherein k_{f} is the first correction coefficient; Tᵢ is the test oil temperature; T₀ is the initial oil temperature; r is the actual rotational speed of the oil pump; r₀ is the preset basic rotational speed of the oil pump; k_{Q} is an adjustment coefficient of the volumetric flow rate; S₁ is the cross area of the second oil inlet pipe; S₂ is the cross area of an oil outlet of the spray nozzle; k_{c} is a shrinkage coefficient; P₀ is the initial pressure of the lubricant; Pᵢ is a test pressure of the lubricant; Qᵥ is a preset basic volumetric flow rate of the oil outlet.

Preferably, the empirical formula of the adjustment coefficient of the volumetric flow rate k_{Q} is:

$${k}_{Q} = λ \cdot \sqrt{\vert \frac{{L}_{2} - {L}_{1}}{{L}_{2}} \vert \cdot {e}^{0.0256 \frac{{a}_{1}}{{a}_{0}}}} \cdot ln ( \frac{{P}_{0}}{{P}_{i}} + 3.43 ) \cdot \frac{2 {π r}^{2}}{180 \cdot ( {S}_{2} - {S}_{1} )} ,$$

wherein λ is the second correction coefficient; L₁ is the length of the first oil pipe; L₂ is the length of the second oil pipe; a₁ is the propagation speed of the lubricant in the first oil pipe; a₂ is the propagation speed of the lubricant in the second oil pipe; r is the radius of the second lubricant pipe.

The present invention has the beneficial effects: according to the intelligent lubricant spraying system proposed by the present invention, the gears and the interface of the lubricant are separated; so, there is no churning loss. The lubricant spraying quantity is intelligently adjusted by detecting the input rotational speed and the input torque of the gear transmission as well as the lubricant quantity in the oil tank. Thus, the gears are always in excellent lubrication state. Poor lubrication caused by insufficient lubricant and extra power loss caused by excessive lubricant are avoided. Furthermore, the rotational speed of the oil pump can be controlled according to the height of the liquid level of the lubricant in the oil tank. When the lubricant quantity of the oil tank is few, the rotational speed of the oil pump is reduced, avoiding idle of the oil pump.

### BRIEF DESCRIPTION OF THE DRAWINGS

FIG. 1 is a schematic structural diagram of an intelligent lubricant spraying system for a high-speed gear transmission in the present invention.

FIG. 2 is a schematic diagram showing the spraying of a spray nozzle in the present invention.

FIG. 3 is a control logic diagram of an intelligent lubricant spraying system for a high-speed gear transmission in the present invention.

FIG. 4 is a schematic diagram showing the control of a PID controller in the present invention.

### DESCRIPTION OF THE EMBODIMENTS

The present invention will be further described in detail below with reference to the accompanying drawings, such that those skilled in the art may implement it by referring to the specification.

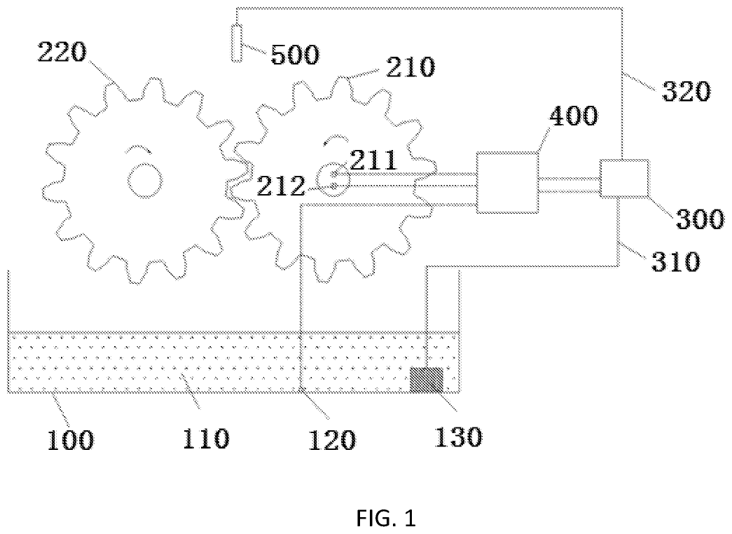

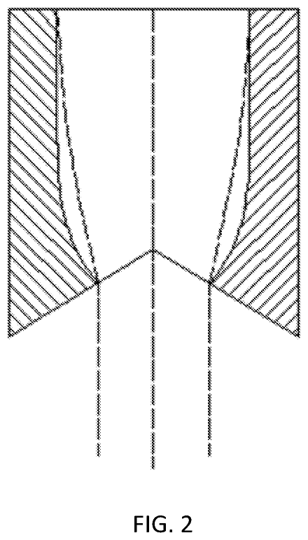

As shown in FIG. 1 and FIG. 2, the present invention proposes an intelligent lubricant spraying system for a high-speed gear transmission, which comprises an oil tank 100, a lubricant 110, a filter 130, a driving gear 210, a driven gear 220, an oil pump 300, a first oil pipe 310, a second oil pipe 320, a controller 400 and a spray nozzle 500.

The lubricant 110 is arranged in the oil tank 100. The driving gear 210 is rotatably supported above the oil tank 100. The driven gear 220 is rotatably supported above the oil tank 100 and is meshed with the driving gear 210. The driving gear 210 rotates to drive the driven gear 220 to rotate.

The bottom of the filter 130 is arranged in the oil tank 100. The filter is used for filtering and purifying the lubricant 110. The bottom of the filter 130 is communicated with an oil inlet in one end of the oil pump 300 through the first oil pipe 310. The lubricant is filtered by the filter 130 and then is guided into the oil pump 300 through the first oil pipe. An oil outlet in the other end of the oil pump 300 is communicated with the spray nozzle 500 through the second oil pipe 320. The spray nozzle 500 is arranged between the driving gear 210 and the driving ear 220 and is located at the common tangent of a pitch circle of the driving gear 210 and the driven gear 220. The lubricant is guided into the spray nozzle 500 through the oil pump 300 and then lubricates a meshing portion of the driving gear 210 and the driven gear 220 through the spray nozzle 500. A liquid level gauge 120 is also arranged in the oil tank 100 and is used for measuring the residual lubricant quantity of the oil tank 100. An oil pump rotational speed sensor is also arranged on the oil pump 300 and is used for detecting the rotational speed of the oil pump 300.

In the present invention, preferably, the first oil pipe 310 and the second oil pipe 320 are high-pressure oil pipes.

In the present invention, preferably, the spray nozzle 500 has a sector-shaped structure.

The driving gear 210 is further provided with a gear rotational speed sensor 211 and a torque sensor 212, which are respectively used for measuring the rotational speed and the torque of the driving gear 210. The controller 400 is respectively and electrically connected with the gear rotational speed sensor 211, the torque sensor 212, the liquid level gauge, the oil pump 300, and the oil pump rotational speed sensor. The controller 400 receives signals transmitted by the gear rotational speed sensor 211, the torque sensor 212, the liquid level gauge 120, and the oil pump, so as to control the lubricant quantity of the oil pump 300.

The present invention further proposes a control method of an intelligent lubricant spraying system for a high-speed gear transmission, which can control the rotational speed of the oil pump according to the height of the lubricant in the oil tank 100, so as to adjust the lubricant spraying quantity and improve the lubricating efficiency of the gear. The control method specifically comprises:

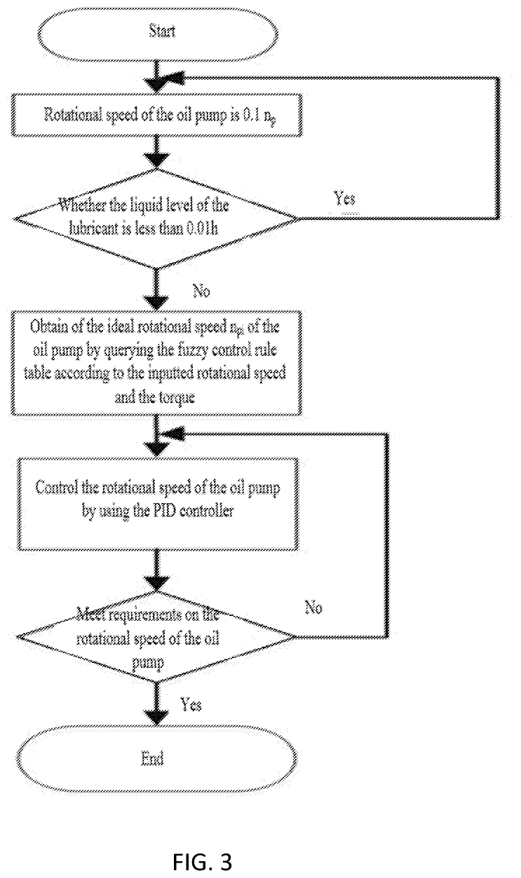

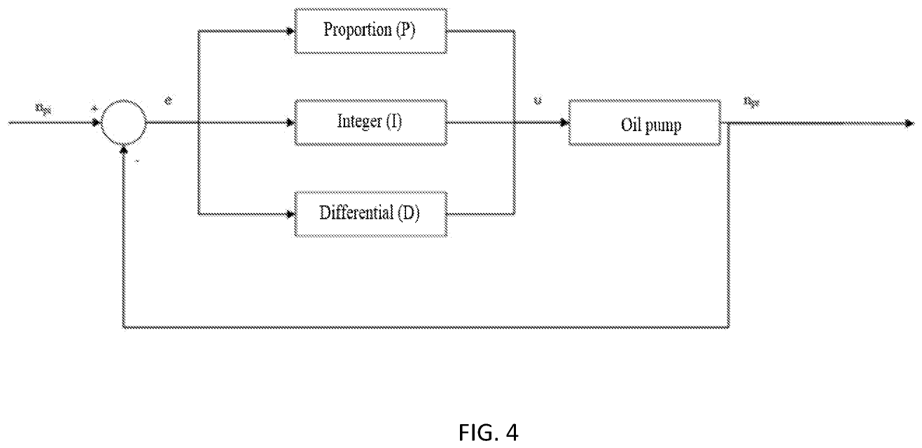

as shown in FIG. 3 and FIG. 4, setting the maximum rotational speed rₘₐₓ of the oil pump 300 to be nₚ, wherein the initial height of the liquid level of the lubricant in the oil tank 100 is h₀, and the lubricant spraying quantity is controlled by controlling the rotational speed r of the oil pump 300;

initially, setting the rotational speed r of the oil pump to be 0.1 nₚ in order to ensure sufficient lubrication between the gears during cold start of the gear transmission; monitoring the height of the liquid level of the lubricant in the oil tank by the liquid level gauge 120;

when the liquid level height h<0.01h₀, maintaining the rotational speed r of the oil pump to be 0.1nₚ, and waiting for the backflow of the lubricant, so as to avoid idle of the oil pump;

when h≥0.01h₀, controlling the actual rotational speed r of the oil pump through a PID controller;

querying the rotational speed v and the torque f of the driving gear 210 in Table 1 which is the fuzzy control rule table of the oil pump, so as to obtain the ideal rotational speed r̅ of the oil pump; controlling the oil pump by using the PID controller to ensure that the rotational speed of the oil pump meets the requirements of the rotational speed, thereby achieving the ideal lubricant spraying quantity;

wherein the torque f of the driving gear 210, the rotational speed v₁ of the driving gear 210, and the ideal rotational speed r̅ of the oil pump are classified into four grades, and an input and output fuzzy set is {vs, S, B, VB};

inputting a deviation e as well as a deviation variation rate ec of the actual rotational speed r of the oil pump and the ideal rotational speed r̅ of the oil pump in the i-th control process into the PID controller; conducting error compensation control on the actual rotational speed r of the oil pump by the PID controller.

The fuzzy control rule of the rotational speed of the oil pump is shown in Table 1. When the torque f is increased, the tooth surface contact force is large; the driving gear 210 and the driven gear 220 are in hybrid lubrication state; rough peaks are in direct contact; friction generates a large amount of the heat; then, a large amount of lubricant is required to cool down the driving gear 210 and the driven gear 220. When the rotational speed v₁ is increased, the tooth surface generates instant temperature rise, and the lubricant is required to cool down it; but, excessive lubricant may cause extra friction loss; so, the PID controller is used to conduct error compensation control on the actual rotational speed r of the oil pump, improving the lubricating efficiency.

The actual rotational speed r of the oil pump is controlled by the PID controller. In the i-th control process, according to the deviation e of the ideal rotational speed r̅ᵢ̅ and the actual rotational speed rᵢ of the oil pump, conducting linear combination on the proportion coefficient K, the integer coefficient I, and the differential coefficient D in the controller to form a controlled variable, so as to control and correct the oil pump. FIG. 4 is a block diagram of the PID controller. r̅ᵢ̅ is the ideal rotational speed of the oil pump, queried in Table 1 in the i-th control process. When e=r̅ᵢ̅−rᵢ, the control rule of the PID is

$$u = K [ e + \frac{1}{I} \cdot \int edt + \frac{D d e}{d t} ] .$$

The function of the proportional coefficient K is to increase the response speed of the system. The function of the integer coefficient I is to eliminate the static error of the system. The function of the differential coefficient D is to improve the dynamic characteristic of the system.

The present invention adopts the cut-and-try to set the proportion coefficient K_{P}, the integer coefficient K_{I}, and the differential coefficient K_{D}. Firstly, proportion correction is only selected, such that the system is enclosed to meet the stability index. On this basis, integer correction is added according to the control deviation, wherein the addition of the integer correction helps the stability margin and the rapidity of the system to reduce. At this time, the differential correction is added to ensure the stability of the rapidity of the system.

TABLE 1
Fuzzy control table of rotational speed of oil pump

| Actual rotational | | Input rotational speed | | | |
|---|---|---|---|---|---|
| speed of the oil pump | | VS | S | B | VB |
| Input | VS | 0.2 | 0.4 | 0.4 | 0.6 |
| rotational | | nₚ | nₚ | nₚ | nₚ |
| torque | S | 0.4 | 0.4 | 0.6 | 0.6 |
| | | nₚ | nₚ | nₚ | nₚ |
| | B | 0.6 | 0.7 | 0.8 | 0.8 |
| | | nₚ | nₚ | nₚ | nₚ |
| | VB | nₚ | nₚ | nₚ | nₚ |

In another embodiment, the empirical formula of the outlet volumetric flow rate Q of the spray nozzle is:

$$Q = {k}_{f} \cdot \frac{{( \frac{{T}_{i} - {T}_{0}}{{T}_{i}} )}^{{e}^{0.118 \frac{r}{{r}_{0}}}} \cdot {( 1 - {k}_{Q} \cdot \frac{{S}_{2}}{{S}_{1}} )}^{2} + 2.4638}{{k}_{c} \cdot \sqrt{0.992 {( \frac{{P}_{0}}{{P}_{i}} )}^{2} + 0.000 \; 7 ( \frac{{P}_{0}}{{P}_{i}} ) - 0.000 \; 2}} \cdot {Q}_{v} ,$$

wherein k_{f} is the first correction coefficient; Tᵢ is the test oil temperature; T₀ is the initial oil temperature; r is the actual rotational speed of the oil pump; r₀ is the preset basic rotational speed of the oil pump; k_{Q} is an adjustment coefficient of the volumetric flow rate; S₁ is the cross area of the second oil inlet pipe; S₂ is the cross area of an oil outlet of the spray nozzle; k_{c} is a shrinkage coefficient; P₀ is the initial pressure of the lubricant; Pᵢ is a test pressure of the lubricant; Qᵥ is a preset basic volumetric flow rate of the oil outlet.

The empirical formula of the adjustment coefficient of the volumetric flow rate Q is:

$${k}_{Q} = λ \cdot \sqrt{\vert \frac{{L}_{2} - {L}_{1}}{{L}_{2}} \vert \cdot {e}^{0.0256 \frac{{a}_{1}}{{a}_{0}}}} \cdot ln ( \frac{{P}_{0}}{{P}_{i}} + 3.43 ) \frac{2 π {r}^{2}}{180 \cdot ( {S}_{2} - {S}_{1} )} ,$$

wherein λ is the second correction coefficient; L₁ is the length of the first oil pipe; L₂ is the length of the second oil pipe; a₁ is the propagation speed of the lubricant in the first oil pipe; a₂ is the propagation speed of the lubricant in the second oil pipe; r is the radius of the second lubricant pipe.

The lubricant spraying quantity is intelligently adjusted by detecting the input rotational speed and the input torque of the gear transmission as well as the lubricant quantity in the oil tank. Thus, the gears are always in excellent lubrication state. Extra power loss does not generate. Furthermore, the rotational speed of the oil pump can be controlled according to the height of the liquid level of the lubricant in the oil tank, so as to adjust the lubricant spraying quantity and improve the lubricating efficiency of the gears.

Although the embodiments of the present invention have been disclosed as above, they are not only limited to the applications listed in the specification and the embodiments, and are fully applicable to various fields suitable for the present invention. Their other changes may be easily accessible to those skilled in the art. Therefore, the present invention is not limited to the specific details and the drawings shown and described herein, without departing from the general concept limited by the appended claims and their equivalent scopes.

1.-9. (canceled)

10. An intelligent lubricant spraying system for a high-speed gear transmission, comprising:
an oil tank;
an oil pump, on end of which is communicated with the oil tank through the first oil inlet pipe;
a driving gear, which is rotatably supported above the oil tank;
a driven gear, which is meshed with the driving gear and is rotatably supported above the oil tank;
a spray nozzle, which is communicated with the other end of the oil tank through the second oil inlet pipe, is supported between the driving gear and the driven gear, and is used for spraying a lubricant in the oil tank into a meshing part of the driving gear and the driven gear.

11. The intelligent lubricant spraying system for a high-speed gear transmission according to claim 10, further comprising:
a filter, one end of which is arranged in the oil tank in a communication manner while the other end is communicated with one end of the oil pump through the first oil inlet pipe.

12. The intelligent lubricant spraying system for a high-speed gear transmission according to claim 11, wherein the first oil inlet pipe and the second oil inlet pipe are high-pressure oil pipes.

13. The intelligent lubricant spraying system for a high-speed gear transmission according to claim 12, wherein the spray nozzle has a sector-shaped structure.

14. The intelligent lubricant spraying system for a high-speed gear transmission according to claim 10, further comprising:
a gear rotational speed sensor, which is arranged on the driving gear and is used for monitoring the rotational speed of the driving gear;
a torque sensor, which is arranged on the driving gear and is used for monitoring the torque of the driving gear;
a liquid level gauge, which is arranged in the oil tank and is used for monitoring the height of the liquid level in the oil tank;
an oil pump rotational speed sensor, which is arranged on the oil pump and is used for detecting the rotational speed of the oil pump;
a controller, which is respectively electrically connected with the gear rotational speed sensor, the torque sensor, the liquid level gauge, and the oil pump and is used for receiving monitoring signals from the gear rotational speed sensor, the torque sensor, the liquid level gauge, and the oil pump, and controlling the rotational speed of the oil pump.

15. The intelligent lubricant spraying system for a high-speed gear transmission according to claim 11, further comprising:
a gear rotational speed sensor, which is arranged on the driving gear and is used for monitoring the rotational speed of the driving gear;
a torque sensor, which is arranged on the driving gear and is used for monitoring the torque of the driving gear;
a liquid level gauge, which is arranged in the oil tank and is used for monitoring the height of the liquid level in the oil tank;
an oil pump rotational speed sensor, which is arranged on the oil pump and is used for detecting the rotational speed of the oil pump;
a controller, which is respectively electrically connected with the gear rotational speed sensor, the torque sensor, the liquid level gauge, and the oil pump and is used for receiving monitoring signals from the gear rotational speed sensor, the torque sensor, the liquid level gauge, and the oil pump, and controlling the rotational speed of the oil pump.

16. The intelligent lubricant spraying system for a high-speed gear transmission according to claim 12, further comprising:
a gear rotational speed sensor, which is arranged on the driving gear and is used for monitoring the rotational speed of the driving gear;
a torque sensor, which is arranged on the driving gear and is used for monitoring the torque of the driving gear;
a liquid level gauge, which is arranged in the oil tank and is used for monitoring the height of the liquid level in the oil tank;
an oil pump rotational speed sensor, which is arranged on the oil pump and is used for detecting the rotational speed of the oil pump;
a controller, which is respectively electrically connected with the gear rotational speed sensor, the torque sensor, the liquid level gauge, and the oil pump and is used for receiving monitoring signals from the gear rotational speed sensor, the torque sensor, the liquid level gauge, and the oil pump, and controlling the rotational speed of the oil pump.

17. The intelligent lubricant spraying system for a transmission according to claim 13, further comprising:
a gear rotational speed sensor, which is arranged on the driving gear and is used for monitoring the rotational speed of the driving gear;
a torque sensor, which is arranged on the driving gear and is used for monitoring the torque of the driving gear;
a liquid level gauge, which is arranged in the oil tank and is used for monitoring the height of the liquid level in the oil tank;
an oil pump rotational speed sensor, which is arranged on the oil pump and is used for detecting the rotational speed of the oil pump;
a controller, which is respectively electrically connected with the gear rotational speed sensor, the torque sensor, the liquid level gauge, and the oil pump and is used for receiving monitoring signals from the gear rotational speed sensor, the torque sensor, the liquid level gauge, and the oil pump, and controlling the rotational speed of the oil pump.

18. A control method of an intelligent lubricant spraying system for a high-speed gear transmission, which utilizes the intelligent lubricant spraying system for a high-speed gear transmission according to claim 10, and specifically comprises:
determining the height h of the liquid level of the lubricant in the oil tank:
when h<0.01h₀, determining that the actual rotational speed r of the oil pump is 0.1n_{P};
wherein h₀ is the initial height of the liquid level of the lubricant in the oil tank; nₚ is the maximum rotational speed of the oil pump;
when h≥0.01 h₀, controlling the actual rotational speed r of the oil pump through a proportional-integral-derivative (PID) controller.

19. A control method of an intelligent lubricant spraying system for a high-speed gear transmission, which utilizes the intelligent lubricant spraying system for a high-speed gear transmission according to claim 11, and specifically comprises:
determining the height h of the liquid level of the lubricant in the oil tank:
when h<0.01h₀, determining that the actual rotational speed r of the oil pump is 0.1nₚ;
wherein h₀ is the initial height of the liquid level of the lubricant in the oil tank; nₚ is the maximum rotational speed of the oil pump;
when h≥0.01h₀, controlling the actual rotational speed r of the oil pump through a proportional-integral-derivative (PID) controller.

20. A control method of an intelligent lubricant spraying system for a high-speed gear transmission, which utilizes the intelligent lubricant spraying system for a high-speed gear transmission according to claim 12, and specifically comprises:
determining the height h of the liquid level of the lubricant in the oil tank:
when h<0.01h₀, determining that the actual rotational speed r of the oil pump is 0.1nₚ;
wherein h₀ is the initial height of the liquid level of the lubricant in the oil tank; nₚ is the maximum rotational speed of the oil pump;
when h≥0.01h₀, controlling the actual rotational speed r of the oil pump through a proportional-integral-derivative (PID) controller.

21. A control method of an intelligent lubricant spraying system for a high-speed gear transmission, which utilizes the intelligent lubricant spraying system for a high-speed gear transmission according to claim 13, and specifically comprises:
determining the height h of the liquid level of the lubricant in the oil tank:
when h<0.01h₀, determining that the actual rotational speed r of the oil pump is 0.1nₚ;
wherein h₀ is the initial height of the liquid level of the lubricant in the oil tank; nₚ is the maximum rotational speed of the oil pump;
when h≥0.01h₀, controlling the actual rotational speed r of the oil pump through a proportional-integral-derivative (PID) controller.

22. A control method of an intelligent lubricant spraying system for a high-speed gear transmission, which utilizes the intelligent lubricant spraying system for a high-speed gear transmission according to claim 14, and specifically comprises:
determining the height h of the liquid level of the lubricant in the oil tank:
when h<0.01h₀, determining that the actual rotational speed r of the oil pump is 0.1nₚ;
wherein h₀ is the initial height of the liquid level of the lubricant in the oil tank; nₚ is the maximum rotational speed of the oil pump;
when h≥0.01h₀, controlling the actual rotational speed r of the oil pump through a proportional-integral-derivative (PID) controller.

23. A control method of an intelligent lubricant spraying system for a high-speed gear transmission, which utilizes the intelligent lubricant spraying system for a high-speed gear transmission according to claim 15, and specifically comprises:
determining the height h of the liquid level of the lubricant in the oil tank:
when h<0.01h₀, determining that the actual rotational speed r of the oil pump is 0.1nₚ;
wherein h₀ is the initial height of the liquid level of the lubricant in the oil tank; nₚ is the maximum rotational speed of the oil pump;
when h≥0.01h₀, controlling the actual rotational speed r of the oil pump through a proportional-integral-derivative (PID) controller.

24. A control method of an intelligent lubricant spraying system for a high-speed gear transmission, which utilizes the intelligent lubricant spraying system for a high-speed gear transmission according to claim 16, and specifically comprises:
determining the height h of the liquid level of the lubricant in the oil tank:
when h<0.01h₀, determining that the actual rotational speed r of the oil pump is 0.1nₚ;
wherein h₀ is the initial height of the liquid level of the lubricant in the oil tank; nₚ is the maximum rotational speed of the oil pump;
when h≥0.01h₀, controlling the actual rotational speed r of the oil pump through a proportional-integral-derivative (PID) controller.

25. A control method of an intelligent lubricant spraying system for a high-speed gear transmission, which utilizes the intelligent lubricant spraying system for a high-speed gear transmission according to claim 17, and specifically comprises:
determining the height h of the liquid level of the lubricant in the oil tank:
when h<0.01h₀, determining that the actual rotational speed r of the oil pump is 0.1nₚ;
wherein h₀ is the initial height of the liquid level of the lubricant in the oil tank; nₚ is the maximum rotational speed of the oil pump;
when h≥0.01h₀, controlling the actual rotational speed r of the oil pump through a proportional-integral-derivative (PID) controller.

26. The control method of an intelligent lubricant spraying system for a high-speed gear transmission according to claim 18, further comprising:
inputting the torque f of the driving gear and the rotational speed v₁ of the driving gear into a fuzzy controller, and outputting the ideal rotational speed r̅ of the oil pump;
wherein the torque f of the driving gear, the rotational speed v₁ of the driving gear, and the ideal rotational speed r̅ of the oil pump are classified into four grades, and an input and output fuzzy set is {vs, S, B, VB};
inputting a deviation e as well as a deviation variation rate ec of the actual rotational speed r of the oil pump and the ideal rotational speed r̅ of the oil pump in the i-th control process into the PID controller; conducting error compensation control on the actual rotational speed r of the oil pump through the PID controller.

27. The control method of an intelligent lubricant spraying system for a high-speed gear transmission according to claim 19, further comprising:
inputting the torque f of the driving gear and the rotational speed v₁ of the driving gear into a fuzzy controller, and outputting the ideal rotational speed r̅ of the oil pump;
wherein the torque f of the driving gear, the rotational speed v₁ of the driving gear, and the ideal rotational speed r̅ of the oil pump are classified into four grades, and an input and output fuzzy set is {vs, S, B, VB};
inputting a deviation e as well as a deviation variation rate ec of the actual rotational speed r of the oil pump and the ideal rotational speed r̅ of the oil pump in the i-th control process into the PID controller; conducting error compensation control on the actual rotational speed r of the oil pump through the PID controller.

28. The control method of an intelligent lubricant spraying system for a high-speed gear transmission according to claim 26, wherein the empirical formula of the outlet volumetric flow rate Q of the spray nozzle is:
$$Q = {k}_{f} \cdot \frac{{( \frac{{T}_{i} - {T}_{0}}{{T}_{i}} )}^{{e}^{0.118 \frac{r}{{r}_{0}}}} \cdot {( 1 - {k}_{Q} \cdot \frac{{S}_{2}}{{S}_{1}} )}^{2} + 2.4638}{{k}_{c} \cdot \sqrt{0.992 {( \frac{{P}_{0}}{{P}_{i}} )}^{2} + 0.000 \; 7 ( \frac{{P}_{0}}{{P}_{i}} ) - 0.000 \; 2}} \cdot {Q}_{v} ,$$
wherein k_{f} the first correction coefficient; Tᵢ is the test oil temperature; T₀ is the initial oil temperature; r is the actual rotational speed of the oil pump; r₀ is the preset basic rotational speed of the oil pump; k_{Q} is an adjustment coefficient of the volumetric flow rate; S₁ is the cross area of the second oil inlet pipe; S₂ is the cross area of an oil outlet of the spray nozzle; k_{c} is a shrinkage coefficient; P₀ is the initial pressure of the lubricant; Pᵢ is a test pressure of the lubricant; Qᵥ is a preset basic volumetric flow rate of the oil outlet.

29. The control method of an intelligent lubricant spraying system for a high-speed gear transmission according to claim 28, wherein the empirical formula of the adjustment coefficient of the volumetric flow rate k_{Q} is:
$${k}_{Q} = λ \cdot \sqrt{\vert \frac{{L}_{2} - {L}_{1}}{{L}_{2}} \vert \cdot {e}^{0.0256 \frac{{a}_{1}}{{a}_{0}}}} \cdot ln ( \frac{{P}_{0}}{{P}_{i}} + 3.43 ) \cdot \frac{2 π {r}^{2}}{180 \cdot ( {S}_{2} - {S}_{1} )} ,$$
wherein λ is the second correction coefficient; L₁ is the length of the first oil pipe; L₂ is the length of the second oil pipe; a₁ is the propagation speed of the lubricant in the first oil pipe; a₂ is the propagation speed of the lubricant in the second oil pipe; r is the radius of the second lubricant pipe.
